(19) United States
(12) Patent Application Publication
(10) Pub. No.: US 2011/0253595 A1
(43) Pub. Date: Oct. 20, 2011

(54) COMBINED SOLID ADSORPTION-HYDROTREATING PROCESS FOR WHOLE CRUDE OIL DESULFURIZATION

(76) Inventors: Esam Zaki HAMAD, Dhahran (SA); Yuguo X Wang, Dhahran (SA)

(21) Appl. No.: 13/090,584

(22) Filed: Apr. 20, 2011

Related U.S. Application Data
(60) Provisional application No. 61/325,898, filed on Apr. 20, 2010.

(51) Int. Cl. C10G 25/05; B01J 8/00; C10G 67/06

(52) U.S. Cl. 208/89; 208/250; 208/245; 196/46; 422/187

(57) ABSTRACT

A whole crude oil desulfurization system and process includes a combination of an adsorption zone and a hydroprocessing zone. This combined process and system reduces the requisite throughput for the hydroprocessing unit, conventionally a very costly and process both in terms of energy expenditures and catalyst depletion. By first contacting the whole crude oil feedstock with an adsorbent for the sulfur-containing compounds, the adsorption effluent having a relatively lower sulfur content can be collected and provided to refiners without further treatment. The adsorbates, including adsorbed organosulfur compounds, are solvent desorbed resulting in a stream containing high levels of organosulfur compounds and a solvent. Following recovery of the solvent, the volume of the sulfur-containing feedstream that remains to be desulfurized in the hydroprocessing zone is substantially less than the original amount of whole crude oil feedstock.

### RELATED APPLICATIONS

This application is related to and claims the benefit of U.S. Provisional Patent Application Ser. No. 61/325,898 filed on Apr. 20, 2010, which is incorporated by reference herein in its entirety.

### BACKGROUND OF THE INVENTION

1. Field of the Invention

This invention relates to improvements in whole crude oil processing, and in particular to an improved method for the desulfurization of whole crude oil.

2. Description of Related Art

Natural petroleum and crude oil deposits are found worldwide over land and sea, having been created based on significantly different ecological and geological conditions since the time before fossil records on Earth. It follows that the compositions and constituents of extracted crude oil is different, and in some cases vastly different. However, virtually all crude oils contain some level of sulfur compounds, including inorganically combined sulfur and organically combined sulfur, i.e., organosulfur compounds. Whole crude oil that contains a relatively low level of sulfur compounds is commonly referred to as “sweet.” Often, recovered whole crude oil contains a substantial level of sulfur compounds, such as hydrogen sulfide, sulfur dioxide, and organosulfur compounds such as mercaptans, organic sulfides, organic sulfoxides, organic sulfones, thiophenes, benzothiophenes, and dibenzothiophenes, which are commonly referred to as “sour.”

Crude oil is generally converted in refineries by distillation, followed by cracking and/or hydroconversion processes, to produce various fuels, lubricating oil products, chemicals, and chemical feedstocks. Fuels for transportation are generally produced by processing and blending distilled fractions from crude oil to meet the particular product specifications. Conventionally, distilled fractions are subject to various hydrocarbon desulfurization processes to make sulfur-containing hydrocarbons more marketable, attractive to customers and environmentally acceptable.

The discharge into the atmosphere of sulfur compounds during processing and end-use of the petroleum products derived from sulfur-containing sour crude oil pose health and environmental problems. The stringent reduced-sulfur specifications applicable to transportation and other fuel products have impacted the refining industry, and it is necessary for refiners to make capital investments to greatly reduce the sulfur content in gas oils to 10 parts per million by weight (ppmw) or less. In the industrialized nations such as the United States, Japan and the countries of the European Union, refineries for transportation fuel have already been required to produce environmentally clean transportation fuels. For instance, in 2007 the United States Environmental Protection Agency required the sulfur content of highway diesel fuel to be reduced 97%, from 500 ppmw (low sulfur diesel) to 15 ppmw (ultra-low sulfur diesel). The European Union has enacted even more stringent standards, requiring diesel and gasoline fuels sold in 2009 to contain less than 10 ppmw of sulfur. Other countries are following in the footsteps of the United States and the European Union and are moving forward with regulations that will require refineries to produce transportation fuels with an ultra-low sulfur level.

Furthermore, the price differential between sour crude oil and sweet crude oil is increasing in favor of sweet crude oil. Hydrocarbon desulfurization processes are required to reduce the sulfur content. However, most desulfurization processing occurs after varying levels of refining of the crude oil. Therefore sour crude oil is sold at a lower price because the purchaser must undertake the expense of desulfurization.

The most common hydrocarbon desulfurization process is hydrotreating, or hydrodesulfurization. In typical hydrotreating processes, hydrogen and a specific distilled hydrocarbon fraction are introduced to a fixed bed reactor that is packed with a hydrodesulfurization catalyst, commonly under elevated operating conditions, which can vary depending on the specific fraction, type and ratio of catalyst, requisite degree of desulfurization, and other factors known to those of ordinary skill in the art. Notably, the temperature and pressure conditions must be further elevated to achieve the low and ultra low sulfur content requirements. However, these operational and capital costs for these elevated conditions are higher, and these elevated conditions often promote conversion of the feed into less desirable intermediates.

Most known advances in the industry for minimizing these undesirable effects include development of more robust hydrotreating catalysts and advanced hydrodesulfurization reactor designs. Alternative processes have also been developed to meet the requirements of decreased sulfur levels in fuels and other petrochemical products.

Conventionally, most oil refineries remove sulfur compounds after the whole crude oil has been fractionated. For example, U.S. Pat. Nos. 6,683,024, 6,864,215, 6,869,522, 6,930,074, 6,955,752 and 7,105,140, and Patent Publication US2001/002931 describe sorbent compositions that are used to desulfurize cracked-gasoline and diesel fuel. U.S. Pat. Nos. 7,0743,24 and 7,291,259 disclose desulfurization of cracked-gasoline and diesel fuel and other refinery fractions. Patent Publication US2005/0075528 describes the use of spent hydrotreating catalyst as adsorbent to treat specific fractions, including gasoline, gas oil, kerosene, or an atmospheric distillation residue.

Other processes are described in which adsorption techniques are used to remove hydrogenatable hydrocarbons, primarily in the context of halogenated hydrocarbons. For instance, U.S. Pat. Nos. 4,952,746 and 4,747,937 generally disclose recovering compounds that can be chemically modified by addition hydrogen. Hydrogentable compounds are adsorbed, and then hydrogenated in a hydrotreating reaction zone. Spent adsorbent is regenerated with an elution solvent, and the combined stream including solvent is processed in a hydrotreating zone. However, such a system only marginally reduces the flow requirements for a hydrotreating zone, since the elution solvent is hydrotreated along with the hydrogenatable compounds. In addition, there is no teaching in U.S. Pat. Nos. 4,952,746 and 4,747,937 of treating whole crude oil to remove organosulfur compounds.

Patent Publication US2005/0205470 discloses a process for selectively removing sulfur from feedstocks such as FCC cracked naphtha, jet fuel or diesel using adsorption. Traditional hydrotreating is suitable for oil fractions, but not for whole crude. However, this is not suitable for treating whole crude oil, as adsorption alone will result in a substantial loss in the overall crude oil volume.

Importantly, none of the above-described references that incorporate adsorption disclose processes that are capable of desulfurizing whole crude oil, prior to refining into its constituent products. As a result, the previously proposed and currently practiced methodologies require relatively greater complexity downstream in operations, due to the need to remove larger amounts of sulfur from naphtha, diesel fuel and other refinery products. In addition, according to the process of the above-described references in which adsorbent materials are used to treat various fractions, no economic benefit is realized at the level of providing whole crude oil to refineries, e.g., directly from the pipeline or the tanker. Furthermore, none of the processes and systems described above reduces the requisite capacity of a hydroprocessing unit, typically an operation where substantial processing costs are directly proportional to the overall volume of crude oil that is processed in a given period of time.

It is therefore an object of this invention to provide a whole crude oil desulfurization process that can reduce the sulfur content while minimizing the required capacity of a hydroprocessing reactor.

It is another object of the invention to balance the expense of whole crude oil desulfurization with the price gain of the product delivered to refiners.

As used herein, the term “whole crude oil” is to be understood to mean a mixture of petroleum liquids and gases, including impurities such as sulfur, as distinguished from refined fractions of hydrocarbons.

As used herein, the term “hydroprocessing” is to be understood to include hydrodesulfurization, hydrocracking, hydrodenitrification, hydrodealkylation and hydrotreating.

### SUMMARY OF THE INVENTION

A primary objective of whole crude oil desulfurization is to convert sour grades of crude oil to more marketable and valuable products for refinery operators. The present invention is directed to a whole crude oil desulfurization system and process that included a combination of an adsorption zone and a hydroprocessing zone. This combined process and system reduces the requisite throughput for the hydroprocessing unit, conventionally a very costly process to operate both in terms of energy expenditures and catalyst depletion.

By first treating the whole crude oil feedstock in the adsorption zone, the adsorption effluent can be collected and provided to refiners without further treatment, and the adsorbates, which include adsorbed organosulfur compounds, are desorbed resulting in a stream containing high levels of organosulfur compounds and a solvent. The solvent is selected such that a major proportion thereof can be conveniently separated and recovered, for instance, by distillation. Accordingly, the volume of liquid feed to be desulfurized in the hydroprocessing zone is substantially less than the original volume of whole crude oil feedstock. This is highly desirable, since a substantial cost of operating a hydroprocessing unit is proportional to the feed volume and not highly sensitive to the sulfur content. Since the cost of an adsorption unit is typically much less than the cost of a hydroprocessing unit, such as a hydrodesulfurization unit, technologically mature units can be operated with desirable cost savings using the novel process and system of the present invention.

In a preferred embodiment, the process of the present invention is operated upstream of the crude distillation unit in a typical crude processing operation. It can be operated, for instance, downstream of the wellhead, before or after the Gas-Oil Separation Plant, upstream of the refinery limits, or within the refinery limits prior to the crude distillation unit.

In the system and process of the present invention, a whole crude oil feedstock is contacted with an adsorbent, typically in an adsorbent bed, on which sulfur-containing compounds are selectively adsorbed. The discharge is generally in the range of about 70% to about 99% of the total volume of the initial feedstock, in which the lower end of the range is applicable to feedstocks containing higher levels of sulfur-containing compounds. The adsorbent is then desorbed with a solvent to extract the adsorbates and regenerate the bed.

In a preferred embodiment of the present invention, at least two parallel adsorbent beds are used to operate continuously, so that while one adsorbent bed is adsorbing the sulfur-containing compounds from the whole crude oil feedstock, referred to herein as an “adsorption cycle,” the other adsorbent bed is regenerated, referred to herein as a “desorption cycle.”

Solvent is recovered and recycled from the mixture of solvent and sulfur-containing adsorbates. The separated hydrocarbon stream containing a relatively higher level of organosulfur compounds is fed to a hydroprocessing unit for desulfurization to produce a low sulfur content effluent. The low sulfur content effluent recovered from the hydroprocessing zone can be recombined with the low sulfur content effluent from the adsorption cycle, or sent to a separate processing pool.

### BRIEF DESCRIPTION OF THE DRAWINGS

The foregoing summary, as well as the following detailed description of preferred embodiments of the invention will be better understood when read in conjunction with the appended drawings. For the purpose of illustrating the invention, there are shown in the drawings embodiments which are presently preferred. It should be understood, however, that the invention is not limited to the precise arrangements and instrumentalities shown. In the drawings the same numeral is used to refer to the same or similar elements, in which:

FIG. 1 is a schematic diagram of one embodiment of an improved whole crude oil desulfurization system in accordance with the invention;

FIG. 2 is a schematic diagram of another embodiment of an improved whole crude oil desulfurization system in accordance with the invention; and

FIG. 3 is a schematic diagram of a further embodiment of an improved whole crude oil desulfurization system in accordance with the invention.

### DETAILED DESCRIPTION OF THE INVENTION

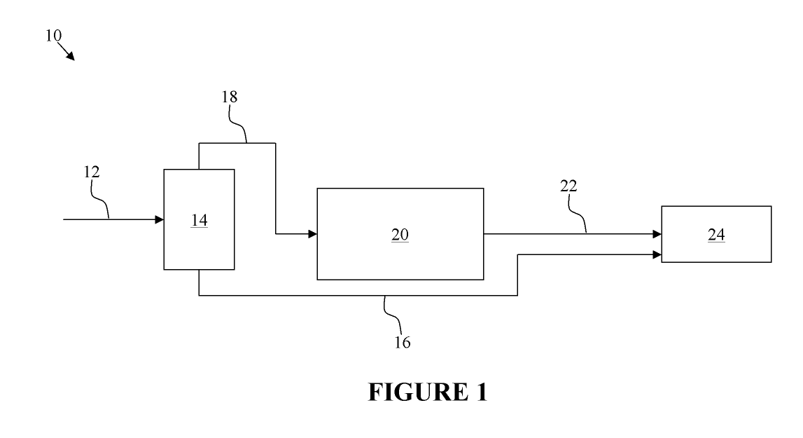

A process for treating whole crude oil containing organosulfur compounds is generally described with respect to FIG. 1. A system 10 includes an adsorption zone 14 and a hydroprocessing zone 20. The process includes contacting a whole crude oil feed stream 12 containing organosulfur compounds with a solid adsorbent material in the adsorption zone 14, wherein organosulfur compounds are adsorbed by the adsorbent material. A treated effluent stream 16 having a reduced organosulfur compound content is recovered from the adsorption zone 14.

When the adsorbent material has reached a predetermined percentage of its adsorption capacity, organosulfur compounds are desorbed from the adsorbent material, e.g., by contacting the adsorbent material with a solvent for the organosulfur compounds. An increased organosulfur compound purge stream 18 is recovered. The increased organosulfur compound purge stream 18 is then desulfurized in the hydroprocessing zone 20, from which a reduced organosulfur compound hydroprocessed stream 22 is recovered. Accordingly, the treated effluent stream 16 having a reduced organosulfur compound content (as compared to the whole crude oil feed stream 12) bypasses the hydroprocessing zone 20. In certain embodiments, the reduced organosulfur compound hydroprocessed stream 22 and the treated effluent stream 16 recovered from the adsorption zone 14 can be collected in a common location 24 or stream 24 (e.g., reservoir, tanker, pipeline, refinery crude feed stream). Alternatively, (not shown), the hydroprocessed stream 22 and the treated effluent stream 16 are collected or transported separately.

The sequence of hydroprocessing after adsorption allows the use of commercial hydroprocessing plant reactors and equipment such as hydrotreating units and provides a significant economic advantage. The cost of building and operating a hydroprocessing unit is generally proportional to the feed volume, and is generally not sensitive to the sulfur content up to about 6 wt %. Therefore, since the cost of adsorption, desorption and other unit operations equipment is generally much less than the cost of hydroprocessing equipment such as hydrotreating units, the same amount of whole crude oil can be desulfurized at a reduced cost using relatively smaller hydrotreating units downstream of the adsorption unit(s), as compared to using only a relatively larger hydrotreating unit to achieve the same or similar level of desulfurization of a give whole crude oil feedstream.

The adsorbent zone 14 can include any type of adsorbent bed or other structure and associated systems for containing adsorbent material. In certain embodiments, the adsorbent material is contained in at least one fixed bed. The adsorbent zone 14 can also be a plurality of fixed beds in parallel, series, or a combination including parallel and series; one or more agitated or non-agitated slurry vessels; or one or more moving bed adsorbers. The whole crude oil feed 12 can be treated in batch, semi-continuous or continuous operation, depending on the type and number of adsorbing units in the adsorption zone 14.

The adsorbent material is characterized by a high capacity and high selectivity for the sulfur compounds that are present in whole crude oils. In general, the adsorbent material has an adsorbent capacity suitable to remove at least about 5 to about 53 weight percent of the organosulfur compounds contained in the original whole crude oil feed stream 12. In certain preferred embodiments, the adsorbent material has an adsorbent capacity suitable to remove at least about 30 weight percent, and in certain embodiments higher levels, of the organosulfur compounds contained in the whole crude oil feed stream 12.

In addition, a suitable adsorbent material can be readily regenerated for repeated use if the adsorption unit. For instance, suitable adsorbent material can be used for at least about 50 cycles, preferably at least about 200 cycles of adsorption and desorption.

Further, the adsorbent material preferably does not react with sulfur gases that can be present in the whole crude oil stream 12, such as hydrogen sulfide gas. Accordingly, unlike other prior art processes that use beds of catalytic to remove hydrogen sulfide, generally by oxidation, organosulfur compounds are adsorbed in a manner that utilizes the “purge” stream to recover whole crude oil, in a purge stream 18 having increased levels of organosulfur compounds.

The adsorbent material/materials can include materials such as zinc oxide, manganese oxide, metals over high surface area supports like silica, alumina, zeolites, activated carbon, mesoporous silica molecular sieves (e.g., Al-MCM-41), and bauxite. Particularly suitable adsorbents that have been identified as having suitable adsorbent capacity for adsorbing organosulfur compounds from whole crude oil streams include alumino silicates such as type Y zeolite (metal promoted, ion-exchanged and other forms) and activated carbon powders. In certain embodiments, a combination comprising at least one of the above mentioned adsorbent materials can be used. For instance, these different adsorbent materials can be admixed, or in staged sections or adsorbent beds (in the case of series adsorbent beds).

The adsorbent preferably includes properties such as pore size that permits the large organosulfur compounds access to the internal adsorption sites. For instance, in a preferred embodiment, adsorbent material is selected that has an average pore diameter of about 10 to about 50 nanometers, a surface area of about 100 to about 500 square meters per gram, a pore volume of about 0.5 to about 0.8 cubic centimeters per gram, and a bulk density of about 0.55 to about 0.75 grams per cubic centimeter. In addition, preferred adsorbent particles are extrudates having a diameter of about 1 to about 5 millimeters and a length of about 0.5 to about 2.5 centimeters.

In preferred embodiments, large pressure drops (e.g., greater than about 0.25 bar/meter) are avoided by selection of suitable adsorbent material (including selection of suitable particle size), and suitable operating conditions such as temperature, pressure and space flow velocity. Operating conditions during adsorption can include: a temperature of ambient to about 70° C., and in certain embodiments ambient to about 50° C.; a pressure of ambient to about 5 bars, and in certain embodiments ambient to about 3 bars; and a liquid hourly space velocity of about 0.5/hour to about 10/hour, and in certain embodiments about 1.0/hour to about 8.0/hour.

The organosulfur compounds from the whole crude oil stream can include mercaptans, organic sulfides, organic sulfoxides, organic sulfones, thiophenes, multi-ring thiophenes, benzothiophenes, dibenzothiophenes and other sulfur-containing organic compounds, and combinations comprising at least one of the foregoing organosulfur compounds. During hydroprocessing, the amount of organosulfur compounds in the purge stream 18 having increased levels of organosulfur compounds are converted to the reduced organosulfur compound hydroprocessed stream 22.

In certain embodiments, sulfurous gases (such as hydrogen sulfide gas) can be removed from the treated effluent 16 with a fractionation process to further reduce the overall sulfur content, as in known to those of ordinary skill in the in the art of hydrotreating. The elemental sulfur can be recovered for commercial sale.

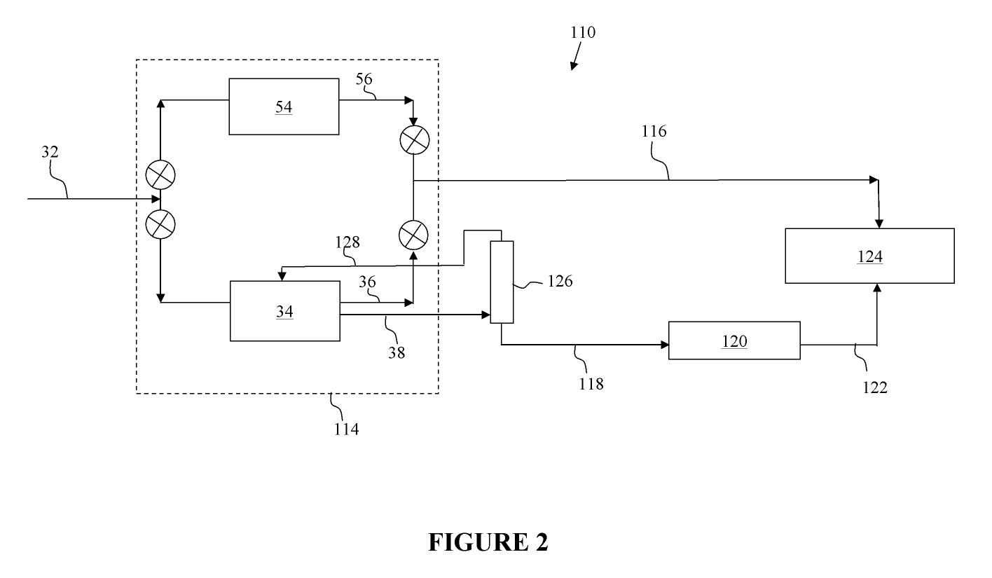

Referring now to FIG. 2, an embodiment of a process and system for desulfurizing whole crude oil (more generally shown with respect to FIG. 1) is shown. A whole crude oil desulfurizing system 110 generally includes at least two parallel adsorption units 34, 54 in an adsorption zone 114. During the adsorption cycle, in which one adsorption unit 54 is adsorbing organosulfur compounds from the whole crude oil stream 32, the other adsorption unit 34 is in the desorption cycle, where it is desorbing the previously adsorbed organosulfur compounds into an increased organosulfur compound purge stream 38.

During an adsorption cycle of the adsorption unit 34, a treated effluent stream 36 having a reduced organosulfur compound content is recovered from the adsorption unit 34. Likewise, during an adsorption cycle of the adsorption unit 54, a treated effluent stream 56 having a reduced organosulfur compound content is recovered from the adsorption unit 54. The treated effluent streams 36, 56 can be directed, for instance, into a treated effluent stream 116.

During a desorption cycle, shown with respect to the adsorption unit 34 in FIG. 2, the adsorbates (including organosulfur compounds adsorbed to the adsorbent material) are desorbed to remove the increased organosulfur compound purge stream 38. A desorption cycle is also carried out in the adsorption unit 54 (not shown). The desorption cycle can commence, for instance, when the adsorbent material in the adsorption unit 34 or 54 has reached a predetermined percentage of its adsorbent capacity. In certain embodiments, the whole crude oils stream 32 is adsorbed until the level of organosulfur compounds has been reduced by a predetermined percentage. The amount of sulfur reduction can be monitored in the treated effluent stream 36, by various processes including but not limited to X-ray florescence.

A semi-continuous operation can be established by adsorbing in the adsorption unit 54 during the desorption cycle of adsorption unit 34, where the whole crude oil stream 32 is directed to the adsorption unit 54 for adsorptive desulfurization. The process can cycle between desorption and adsorption as needed.

The adsorption bed 34 can be regenerated by various methods. Furthermore, upon regeneration of the adsorbent material, at least about 95%, preferably at least about 99%, of the adsorbate is removed.

In the schematic diagram of FIG. 2, the desorption cycle employs a stripping solvent. The stripping solvent used in the process of the present invention is characterized by the following properties:
a. the ability to dissolve sulfur organic compounds;
b. it is in a liquid phase or supercritical state at the stripping conditions; and
c. sufficiently volatile for reuse after separation of sulfur compounds.
   In addition, economic considerations are important. Examples of suitable stripping solvents include toluene, hexane, butane, pentane, or combinations comprising at least one of the foregoing solvents. In certain embodiments, toluene is a desirable stripping solvent as it is an inexpensive aromatic solvent, thereby increasing the solubility of a greater portion of aromatic organosulfur compounds. Hexane, pentane and butane will dissolve a smaller portion of the aromatic sulfur compounds, especially those with multiple aromatic rings and nitrogen heteroatoms, in addition to sulfur, but energy savings in recovering the solvent are realized.

The adsorbent in the adsorption unit 34 is contacted with a stripping solvent in a desorbing stream 128. The purge stream 38 from the desorption cycle therefore includes organosulfur compounds and stripping solvent. All or a substantial portion of the stripping solvent used in the purge stream 38 is recovered, for instance, in a distillation unit 126.

The effluent from the distillation unit 126, a hydrocarbon stream 118 having an increased level of organosulfur compounds, is then processed in the hydroprocessing zone 120 for desulfurization. A hydroprocessed stream 122 having a reduced level of organosulfur compounds is recovered.

In certain embodiments, the hydroprocessed stream 122 and the treated effluent stream 116 recovered from the adsorption zone 114 can be collected in a common location 124 or stream 124. Alternatively, (not shown), the hydroprocessed stream 122 and the treated effluent stream 116 are collected or transported separately.

Operating conditions during desorption, for instance using toluene as a stripping solvent, can include: a temperature of ambient to about 70° C., and in certain embodiments ambient to about 50° C.; a pressure of ambient to about 5 bars, and in certain embodiments ambient to about 3 bars; and a liquid hourly space velocity of about 0.5/hour to about 10/hour, and in certain embodiments about 1.0/hour to about 8.0/hour.

The operating conditions for adsorption and desorption can be similar, realizing process economics and configuration advantages related to heating or cooling the bed. Since typical stripping solvents have relatively low viscosity levels, there is a lower pressure drop across the bed, or a higher velocity at the same pressure drop. For butane and lighter hydrocarbons, stripping can be accomplished in a liquid phase or supercritical state, and the pressure and temperature conditions should be set accordingly, i.e., such that the fluid is in its liquid state with the temperature below the solvent's critical temperature and the pressure above the solvent's vapor pressure, and such that the fluid is in the supercritical state with the temperature slightly above the solvent's critical temperature point and the pressure around the solvent's critical pressure.

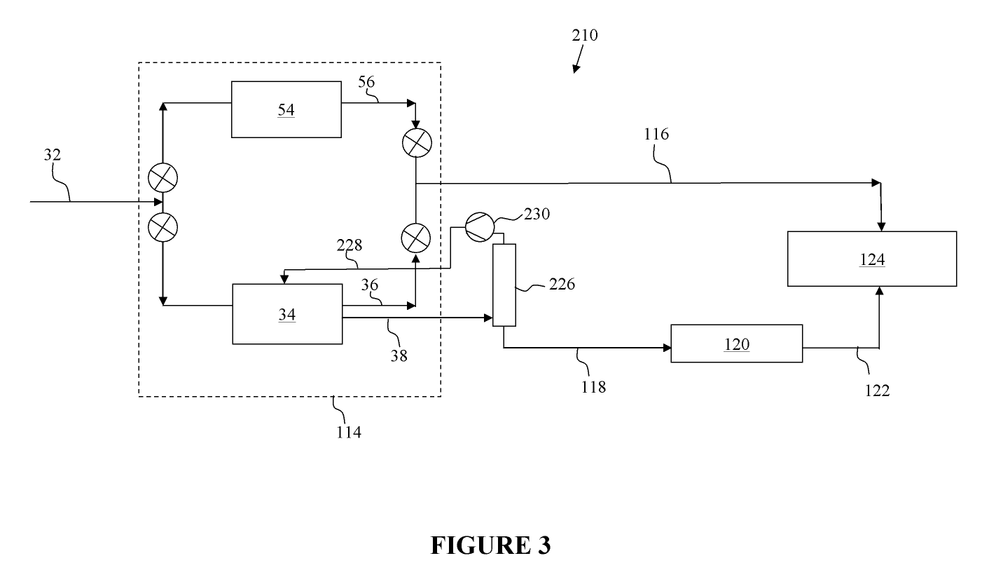

In a further embodiment of a process and system for desulfurizing whole crude oil, and referring now to FIG. 3, a system 210 is shown similar to system 110 described with respect to FIG. 2, with the use of compressed gas or supercritical solvent. For instance, system 210 can use as a stripping agent one or more of supercritical carbon dioxide, supercritical ethane, supercritical ethylene, supercritical propane and supercritical butane.

During a desorption cycle, shown with respect to the adsorption unit 34 in FIG. 3, the adsorbates (including organosulfur compounds adsorbed to the adsorbent material) are desorbed to remove purge stream 38 having an increased level of organosulfur compounds. A desorption cycle is also carried out in the adsorption unit 54 (not shown). The desorption cycle can commence, for instance, when the adsorbent material in the adsorption unit 34 or 54 has reached a predetermined percentage of its adsorbent capacity. In certain embodiments, the whole crude oils stream 32 is adsorbed until the level of organosulfur compounds has been reduced by a predetermined percentage, for instance, ranging from about 5 to 53 weight percent, preferably about 30 to 53 percent.

A solvent desorbing stream 228 is passed through the adsorption unit 34. The purge stream 38 from the desorption cycle therefore includes desorbed adsorbate, i.e., organosulfur compounds, and solvent. At least a portion, and preferably, substantially all, of the solvent used in the desorption cycle purge stream 38 is recovered, for instance, in a separation unit 226, such as a distillation unit. The solvent is recompressed in a compressor 230, for instance, during continued desorption in a desorption cycle, or when needed in a subsequent desperation cycle. The increased organosulfur compound whole crude oil stream 118 can then be processed in the hydroprocessing zone 120 for desulfurization, and a hydroprocessed stream 122 having a reduced level of organosulfur compounds is recovered, as discussed above.

Operating conditions during desorption, for instance using supercritical carbon dioxide as a stripping solvent, can include a temperature of generally about 31° C. to about 70° C. and a pressure of about 72 to about 1000 bars with a liquid hourly space velocity of about 0.5/hour to about 20/hour. In preferred embodiments, operating conditions during adsorption can include a temperature of generally about 31° C. to about 70° C. and a pressure of about 72 bars to about 200 bars with a liquid hourly space velocity of about 1.0/hour to about 10/hour.

In the processes described herein, unlike conventional desulfurization processes, gaseous sulfur components of the whole crude oil stream (such as hydrogen sulfide) are not the targets of the adsorption process. Rather, organosulfur compounds, mercaptans, organic sulfides, organic sulfoxides, organic sulfones, thiophenes, benzothiophenes, multi-ring thiophenes such as dibenzothiophenes, and other sulfur-containing organic compounds are the desired adsorbates, and hydrogen sulfide is substantially not adsorbed. Thus, the reduced organosulfur compound adsorbent effluent stream is discharged having substantially the same amount of hydrogen sulfide gas as the whole crude oil stream. This treated effluent stream can be further subjected to a fractionation process to remove the gas phase containing hydrogen sulfide gas prior to delivery, storage or combination with the hydrotreated desulfurized stream described herein.

### EXAMPLES

The following examples illustrate specific embodiments of the method(s) of this invention. The scope of this invention is not to be considered as limited by the specific embodiments described therein, but rather as defined by the claims.

Example 1

In this example, 3 grams of type Y zeolite powder was activated in a vacuum oven at 175° C. and a gauge pressure of 14 psig overnight. The Y zeolite powder was then cooled to room temperature and placed in a 100 ml wide-mouth bottle, to which 15 grams of crude oil having a total sulfur content of 3.01 wt % was added. The mixture was mechanically shaken for 8 hours to reach adsorption equilibrium. After the shaking was stopped, the zeolite powder was allowed to settle by gravity and the upper liquid layer was analyzed for total remaining sulfur which was found to be 1.4 wt %. The liquid was then decanted from the bottle and the remaining solid was washed with 30 grams of toluene. Analysis by X-ray fluoresce indicates that the toluene removed 67% of the total sulfur from the adsorbent.

### Example 2

Example 1 was repeated, except that Ni-Y zeolite powder (prepared by ion exchange) was employed as the adsorbent. The remaining total sulfur in the liquid was 1.2 wt % and toluene removed 54 wt % of the total sulfur from the adsorbent.

### Example 3

Example 1 was repeated, except that H-Y zeolite pellets were employed as the adsorbent. The remaining total sulfur in the liquid was 2.87 wt % and toluene removed almost 100 wt % of the total sulfur from the adsorbent.

### Example 4

Example 1 was repeated, except that activated carbon powder was employed as the adsorbent. The remaining total sulfur in the liquid was 2.61 wt % and toluene removed 100 wt % of the total sulfur from the adsorbent.

The process of the invention has been described and explained with reference to the schematic process drawings and examples. Additional variations and modifications will be apparent to those of ordinary skill in the art based on the above description and the scope of the invention is to be determined by the claims that follow.

What is claimed is:

1. A process for treating whole crude oil containing organosulfur compounds comprising:
a. contacting a whole crude oil feed stream containing organosulfur compounds with a solid adsorbent material, wherein organosulfur compounds are adsorbed by the adsorbent material;
b. recovering a treated effluent stream having a reduced level of organosulfur compounds; and
c. desorbing at least a portion of the organosulfur compounds from the adsorbent material, and recovering a purge stream having an increased level of organosulfur compounds from the adsorbent material.

2. The process as in claim 1, further comprising:
d. hydroprocessing the purge stream and recovering a hydroprocessed stream having a reduced level of organosulfur compounds.

3. The process as in claim 1, wherein the adsorbent material is contained in at least one fixed bed.

4. The process of claim 1, wherein the hydroprocessed stream is combined with the treated effluent stream.

5. The process of claim 1, wherein the treated effluent stream is further subjected to a fractionation process to remove a gas phase that contains at least hydrogen sulfide gas.

6. The process of claim 1, wherein the treated effluent stream contains at least about 5 to 53 weight percent less organosulfur compounds than the whole crude oil stream.

7. The process of claim 1, wherein the treated effluent stream contains at least about 30 to 53 weight percent less organosulfur compounds than the whole crude oil stream.

8. The process of claim 1, wherein the desorbing step employs a stripping solvent.

9. The process of claim 8, further comprising:
recovering a desorbed purge stream containing at least a portion of the stripping solvent and the increased organosulfur compound purge stream.

10. The process of claim 9, wherein at least a portion of the stripping solvent in the desorbed purge stream is distilled and recycled.

11. The process of claim 8, wherein the stripping solvent comprises a solvent selected from the group consisting of toluene, hexane, butane, pentane and combinations comprising at least one of the foregoing solvents.

12. The process of claim 8, wherein the stripping solvent comprises toluene.

13. The process of claim 1, wherein the desorbing step employs a supercritical fluid.

14. The process of claim 13, further comprising:
recovering a desorbed purge stream containing at least a portion of the supercritical fluid and the increased organosulfur compound purge stream.

15. The process of claim 14, wherein at least a portion of the supercritical fluid in the desorbed purge stream is compressed and reused as the stripping solvent.

16. The process of claim 13, wherein the supercritical fluid comprises a supercritical fluid selected from the group consisting of supercritical carbon dioxide, ethane, supercritical ethylene, supercritical propane, supercritical butane and combinations comprising at least one of the foregoing supercritical fluids.

17. The process of claim 13, wherein the supercritical fluid comprises supercritical carbon dioxide.

18. The process of claim 1, wherein the adsorbent material has an adsorbent capacity, and wherein contacting comprises:
passing the whole crude oil feed stream through a first adsorbing bed containing adsorbent material until the adsorbent material in the first adsorbing bed has reached a predetermined percentage of its adsorbent capacity; and
passing the whole crude oil feed stream through a second adsorbing bed containing adsorbent material when the adsorbent material in the first adsorbing bed has reached the predetermined percentage of its adsorbent capacity.

19. The process of claim 18, further comprising desorbing the first adsorbing bed while the whole crude oil feed stream is passed through the second adsorbing bed.

20. The process of claim 18, wherein the predetermined percentage is greater than at least 95%.

21. The process of claim 1, wherein the adsorbent material is selective to organosulfur compounds including but not limited to mercaptans, organic sulfides, organic sulfoxides, organic sulfones, thiophenes, benzothiophenes dibenzothiophenes, other multi-ring thiophenes, and combinations comprising at least one of the foregoing organosulfur compounds.

22. The process of claim 1, wherein the adsorbent material is selected from the group of materials consisting of Y-zeolites, active carbon powders and a combination comprising at least one of the foregoing materials.

23. The process of claim 1, wherein hydroprocessing is selected from the group consisting of hydrodesulfurization, hydrocracking, hydrodenitrification, hydrodealkylation and hydrotreating.

24. A process for treating whole crude oil to reduce its sulfur content comprising:
passing a whole crude oil feed stream containing organosulfur compounds through a solid adsorbent material, wherein organosulfur compounds are adsorbed by the adsorbent material and a reduced organosulfur compound absorbent effluent stream is discharged;
desorbing the organosulfur compounds from the adsorbent material with a stripping fluid, wherein at least a portion of adsorbed organosulfur compounds are desorbed and discharged in a desorbed purge stream having increased organosulfur compounds and stripping fluid,
removing at least a portion of the stripping fluid from the desorbed purge stream; and
hydrotreating the remaining desorbed purge stream resulting in a hydrotreated reduced organosulfur compound stream.

25. The process of claim 24, wherein the reduced organosulfur compound adsorbent effluent stream is combined with the hydrotreated reduced organosulfur compound stream.

26. The process of claim 24, wherein the stripping stream is a stripping solvent.

27. The process of claim 24, wherein the stripping stream is a supercritical fluid.

28. A method for processing of whole crude oil comprising:
adsorbing a whole crude oil stream having organosulfur compounds and hydrogen sulfide gas through adsorbent material selective to organosulfur compounds, wherein organosulfur compounds are adsorbed by the adsorbent material, and hydrogen sulfide is substantially not adsorbed an reduced organosulfur compound adsorbent effluent stream is discharged having substantially the same amount of hydrogen sulfide gas;
desorbing the organosulfur compounds adsorbed by the adsorbent material to recover an increased organosulfur compound purge stream from the adsorbent material; and
hydrotreating the increased organosulfur compound purge stream and recovering a hydrotreated reduced organosulfur compound stream.

29. A system for treating whole crude oil to reduce its sulfur content comprising:
an adsorption unit containing a solid adsorbent material operating in an adsorption cycle for adsorbing organosulfur compounds from a whole crude oil feedstock and providing a treated effluent having a reduced level of organosulfur compounds as compared to the feedstock; and a desorption cycle for desorbing adsorbed organosulfur compounds with a solvent and discharging a purge stream having an increased level of organosulfur compounds;
a separation unit for recovering solvent from the purge stream; and
a hydroprocessing zone for hydroprocessing the remaining purge stream and discharging a hydroprocessed effluent having a reduced level of organosulfur compounds as compared to the feedstock.
